(19) United States
(12) Patent Application Publication
(10) Pub. No.: US 2026/0279364 A1
(43) Pub. Date: Sep. 17, 2026

(54) Optimized processing for reducing channels of a stereophonic audio signal

(71) Applicant: ORANGE, Issy-les-Moulineaux (FR)

(72) Inventors: Stéphane RAGOT, CHATILLON (FR); Alexandre GUERIN, CHATILLON (FR); Arnaud LEFORT, CHATILLON (FR)

(21) Appl. No.: 19/473,278

(22) PCT Filed: Apr. 10, 2024
(86) PCT No.: PCT/EP2024/059645

§ 371 Date: Oct. 7, 2025

(30) Foreign Application Priority Data
Apr. 13, 2023 (FR) FR2303719
Apr. 27, 2023 (FR) FR2304288
May 23, 2023 (FR) FR2305109

(51) Int. Cl. G10L 19/008

(52) U.S. Cl. CPC G10L 19/008

(57) ABSTRACT

A method and downmixing device for downmixing a stereophonic signal in order to obtain a monophonic signal. The method includes: applying, to a current frame of the signal, two downmixing operations, one of the downmixing operations using filtering with rephasing on at least one of the channels of the stereophonic signal and the other downmixing operation not using filtering with rephasing; and selecting one of the processing operations to be applied to the current frame, the selection being implemented depending on: the presence or absence of at least one transient in the stereophonic signal, or a quality level of the filtering of the stereophonic signal used when implementing the processing operation using the filtering of the stereophonic signal.

### TECHNICAL FIELD

The present invention relates to the general field of processing audio signals. The invention relates, in particular, to downmixing of a multichannel audio signal. Downmixing of a stereophonic signal to a monophonic signal is of particular interest.

This type of processing is generally applicable in the field of audio technologies, and more specifically in the field of audio coding, whether it is in the coding or decoding step.

### PRIOR ART

Downmixing consists in deducing, on the basis of a combination of the C channels of a multichannel signal x, a signal y consisting of a smaller number D of channels. In practice, this consists in defining a function ƒ(⋅) such that:

$$m ( n ) = [ \begin{matrix}{m}_{1} ( n ) \\ ⋮ \\ {m}_{D} ( n )\end{matrix} ] = f ( x ( n ) ) = f ( [ \begin{matrix}{x}_{1} ( n ) \\ ⋮ \\ {x}_{C} ( n )\end{matrix} ] ) ,$$

with D<C and n representing a temporal index of the input and output signal.

In this invention, the particular case D=1 and C=2 is of interest; reference will, then, be made to stereo-to-mono downmixing or simply to mono downmixing. In the case C=2, reference is made to 2-channel content or signal, which may be stereo content or binaural content, where channel 1 (x₁) is referenced as the left channel (Left), and channel 2 (x₂) as the right channel (Right). Below, the stereo case will be seen as a general 2-channel signal, including the binaural case in order to avoid repeating the two terms, even if technically a binaural signal has specific characteristics. In the case of the signal y obtained after downmixing, reference is made to a monophonic or mono signal, which will be noted m(n), in the time domain, or M(k), in the frequency domain, below.

These stereo signals may result from capture by a pair of stereo microphones or binaural capture, or even from artistic mixing of audio tracks.

There is a certain number of pairs of microphones which make it possible to create stereo content. Among the most popular, mention may be made of the XY pair composed of 2 cardioid microphones exhibiting a difference in orientation angle of between 90° and 135°. The MS (mid-side) pair is another very widespread pair composed of a microphone of cardioid directivity and of a second microphone, referred to as a “figure of 8” microphone, oriented at 90°. By combining these 2 mics (sum/difference), the left and right stereo content channels may be created. These pairs are referred to as coincident pairs, that is to say that the microphone capsules do not exhibit a delay between them, the spatialization being perceived by the difference in sound intensity between the left channel and right channel.

Another category of pairs referred to as phase stereophony pairs consists in using microphones which are distant from one another, thus creating a phase difference between the channels for the sources located closer to one of the mics. The most known is the AB pair, which utilizes 2 omnidirectional microphones spaced apart by a few centimeters to several meters. Another very widespread pair is the ORTF pair, which utilizes both a phase difference through a spacing of 17 cm of the microphones and an amplitude difference through cardioid directivities (the microphones exhibit an angle of around 90°). The binaural pair consists in placing omnidirectional microphones in the ears of a person or of an artificial head: this type of device makes it possible to create binaural content natively, which may be listened to through the headset.

Stereo content also includes speech and audio signals resulting from audio mixing or audio postproduction (for example, channels stored on a CD or a DVD, or broadcast over the Internet).

There are also other methods for creating stereo content, which are not reviewed here.

The simplest method for creating a signal reduced by downmixing is that referred to as passive downmixing. It consists in taking an average of the left channel and right channel of the stereo signal such that:

$$m ( t ) = \frac{{x}_{1} ( t ) + {x}_{2} ( t )}{2}$$

or, in the frequency domain:

$$M ( t , k ) = \frac{{X}_{1} ( t , k ) + {X}_{2} ( t , k )}{2}$$

where Xᵢ(t,k), i=1, 2 is the fast Fourier transform xᵢ(t) (FFT), k being the index of the frequency and t the index of the frame:

$${X}_{i} ( t , k ) = {\sum }_{l = 0}^{L - 1} w ( l ) \cdot {\check{x}}_{i} ( t , l ) {e}^{- \frac{j 2 π l k}{N}} ,$$

for any k∈{0, . . . , N−1}
where j is the imaginary number such that j=\sqrt{−1}, t is the index of the frame, l is the temporal index in the current frame, N the size of the FFT, w(⋅) a sine or Hann or other apodization window of size L, adapted to the size of the frame, and x̌ᵢ(t,l)=xᵢ(t,l). This definition extends to the case where N>L and x̌ᵢ(⋅) is an augmented version of xᵢ(t) with 0s (0-padding).

This passive downmixing method, which is very simple, operates well in situations in which the right channel and left channel are in phase. However, in situations in which the microphones are not coincident and exhibit phase differences, such mixing generates comb filtering, which is manifested by coloration of the original signal. This is due to the fact that, depending on the spacing of the microphones, on the position of the source with respect to the pair of microphones and on the frequency, the left channel and right channel of the same source may be either in phase, as depicted in FIG. 1a, or in phase opposition as depicted in FIG. 1b. Thus, when downmixing, the left signal and right signal will either add (constructive interference) or cancel out (destructive interference), thus creating variations in level and effects of coloration of the reduced signal m(t). The coloration comes from the effect of comb filtering: the effects of constructive and destructive interference are manifested in different frequency bands, thus modifying the balance and thus the tone of the signal resulting from the downmixing with respect to the original.

In order to correct this defect of intensity level according to frequencies, the downmixing of the e-AAC+ codec implements level correction γ(k) which ensures that the energy level of the reduced signal, in each frequency band, remains comparable to the original one:

$$M ( k ) = γ ( k ) \cdot \frac{{X}_{1} ( k ) + {X}_{2} ( k )}{2} , with$$

$$γ ( k ) = \sqrt{\frac{{\vert {X}_{1} ( k ) \vert}^{2} + {\vert {X}_{2} ( k ) \vert}^{2}}{0.5 {\vert {X}_{1} ( k ) + {X}_{2} ( k ) \vert}^{2}}}$$

This approach makes it possible to compensate, to a certain extent, for the drop in intensity of the downmixing. However, this compensation leads to overamplifications when the signals are close to phase opposition: also, in practice, the correction factor γ(k) is limited to a maximum value (for example, an upper limit of 2).

FIG. 7 describes a method for reducing stereo channels to mono which is integrated into the public candidate IVAS codec which is available at the address: https://forge.3gpp.org/rep/ivas-codec-pc/ivas-codec/-/tree/main

The signal x(m) with 2 input channels, where m is the index of the interleaved samples, is deinterleaved (block 701) to find both the left channel and the right channel. Next, a frequency analysis with windowing and Fourier transform (blocks 702 and 703) is performed in order to obtain the spectra of the 2 channels, and the intercorrelation on the basis of the phase spectra is estimated before determining the time (block 704) difference between the channels (here labeled ITD even though it is formally an ICTD between 2 channels) by 2 searching for a peak (block 705); the block 705 also provides the correlation level R* corresponding to the ITD.

The mixing factor g is then determined as follows (block 706):

$$g = \{ \begin{matrix}\frac{1}{2} - \frac{{R}^{*}}{2} & τ > 0 \\ \frac{1}{2} + \frac{{R}^{*}}{2} & τ < 0 \\ \frac{1}{2} & τ = 0\end{matrix}$$

where g represents the mixing factor and τ is the inter-channel time difference (incorrectly called the ITD). Thus, the 2 channels are combined into a mono signal in the block 706 according to this factor g, with smoothing of the value of the factor applied sample by sample at the start of each frame after the block 707:

$$m ( n ) = γ ( n ) {x}_{1} ( n ) + ( 1 - γ ( n ) ) {x}_{2} ( n ) ,$$

where γ(n) is the factor derived from g after temporal smoothing with the gain of the previous frame.

Next, the energies of the left channel x₁(n) and right channel x₂(n) and of the e mono signal m(n) are determined (blocks 708, 709, 710). The left channel and right channel are separately reinjected (added), in the blocks 713 and 715, into the mono signal resulting from the block 706 depending on energy compensation determined in the block 711 with respective scale factors defined in the blocks 712 and 713.

These methods, in addition to the coloration of the signal resulting from the downmixing, linked to the imperfectly corrected comb filtering, suffer from surplus reverberation linked to the summation of signals when the input channels are out of phase, and from a “click” artifact when channels are reinjected punctually into a single frame. Compensating for a delay which is identical for all the frequencies is not realistic, this delay being linked to the various sources composing the content. In practice, t besides additional coloration, to a potential loss of intelligibility of the sources, which defect level compensation cannot correct.

Other downmixing approaches seek to avoid the aforementioned defects. The principle of these methods is to rephase the left signal and right signal before they are summed. In the document entitled “A stereo to mono downmixing scheme for MPEG-4 parametric stereo encoder” by Samsudin, E. Kurniawati, N. Boon Poh, F. Sattar, S. George, in Proc. ICASSP, 2006, a method which consists in applying, in the frequency domain, a phase shift φ to one of the channels, generally the right one, in order to rephase it with the left channel, is proposed, such that:

$$M ( k ) = \frac{{X}_{1} ( k ) + {X}_{2} ( k ) \cdot {e}^{- j φ ( k )}}{2}$$

The ideal phase shift is given by what is called here the IPD (inter-channel phase difference):

$$IPD ( k ) = ∠ ( {X}_{1} ( k ) \cdot {X}_{2}^{*} ( k ) )$$

where X* is the conjugate of X and ∠ indicates the phase of the complex operand.

It is calculated in the frequency domain: this makes it possible to rephase the spectral components of various sources, a source with its own IPD being able to be preponderant in a frequency band k, while another source with a different IPD may be preponderant at another frequency k′.

In the case of the MPEG4 codec described in the Samsudin document cited above, the IPD applied is that estimated by averaging over a Bark band and not the IPD calculated for each frequency band, the latter proving to be particularly noisy and variable from one frame to the next. In addition, this method takes the left channel as phase reference and, if the phase of this channel is poorly conditioned, the downmixing has a degraded quality.

In the published patent application WO2017103418, a downmixing method which mixes the method proposed by Samsudin and passive downmixing is proposed. Notably, it proposes an ISD (inter-spectral distance) indicator which makes it possible to choose, frequency band by frequency band, which is the most suitable method for rephasing the signals:

$$ISD ( k ) = \frac{\vert {X}_{1} ( k ) - {X}_{2} ( k ) \vert}{\vert {X}_{1} ( k ) + {X}_{2} ( k ) \vert}$$

This indicator makes it possible to measure whether the signals are in phase (ISD<1), that is to say with a phase difference or IPD in the interval

$$[ - \frac{π}{2} , \frac{π}{2} ] ,$$

or rather in phase opposition (ISD>1), i.e. with an IPD in the interval

$$[ \frac{π}{2} , \frac{3 π}{2} ] .$$

When they are in phase opposition, a high ISD value is synonymous with a comparable level between the left channel and the right channel and rephasing is important to avoid the effects of coloration and of dropout. By contrast, an ISD value which is close to 1 is representative of one channel which is preponderant with respect to the other; in this latter case, rephasing is unimportant, since downmixing is almost equal to the preponderant signal. It is, however, important to avoid modifying the phase of the right channel if the latter is preponderant. Thus, in this patent application, a following downmixing selection mechanism is proposed:

$$\{ \begin{matrix}M ( k ) = \frac{{X}_{1} ( k ) + {X}_{2} ( k ) \cdot {e}^{- jIPD ( k )}}{2} , & if ISD ( k ) > 1.3 \\ M ( k ) = \frac{{X}_{1} ( k ) + {X}_{2} ( k )}{2} , & if ISD ( k ) < 1.3\end{matrix}$$

The passive downmixing proposed in the patent application WO2017103418, for situations of low ISD, sometimes introduces increased reverberation.

Moreover, the method proposed in this patent application requires the application of a processing operation in the frequency domain, the reduced signal being reconstructed on the basis of the inverse short-time Fourier transform (STFT) of the signal M(t,k). This type of filtering generates a circular convolution which creates audible artifacts: echo, pre-echo and static. In order to mask these artifacts, an implementation with frame overlap associated with suitable windowing (analysis and/or synthesis window) guaranteeing reconstruction of the filtered signal may be used. Generally, this overlap is not compatible with the operation of the audio coders which with work the adjacent frames, i.e. without overlap; in addition, this type of reconstruction leads to a delay, generally of half a frame, which is the conventional overlap, which is not acceptable for a coder which has strong constraints in terms of latency.

Another overlap-add (OLA) implementation is also possible: this method requires a step of 0-padding the signals and the filters in order to avoid circular convolution. However, tests show that with such filters, the phase of which varies very rapidly from one frame to the next, an OLA approach does not make it possible to mask artifacts completely at the transition of certain frames, the artifacts then remaining audible.

There is also, in the methods of the prior art in which downmixing is obtained by switching, for example in the frequency domain for the published patent application WO2017103418, different downmixing methods. In this case, it is important to ensure that switching takes place “seamlessly”, that is to say without discontinuities or differences in levels between methods for avoiding artifacts.

### DISCLOSURE OF THE INVENTION

The invention aims to improve the prior art.

To this end, the invention targets a method for downmixing a stereophonic signal in order to obtain a monophonic signal, for downmixing a stereophonic signal in order to obtain a monophonic signal, comprising the following:
applying, to a current frame of said signal, two downmixing operations, one of the downmixing operations using filtering with rephasing on at least one of the channels of the stereophonic signal and the other downmixing operation not using filtering with rephasing,
selecting one of said processing operations to be applied to the current frame, said selection being implemented depending on:
a presence or absence of at least one transient in the stereophonic signal, or
a quality level of the filtering of the stereophonic signal used when implementing the processing operation using the filtering of the stereophonic signal.

The invention advantageously provides two decision criteria which make it possible to choose between two different downmixing operations, one of which uses filtering of the stereophonic signal and the other of which does not.

In one embodiment, if a presence of said at least one transient is detected, or not detected, in the stereophonic signal, the downmixing operation which does not use filtering of the stereophonic signal, or which uses filtering of the stereophonic signal, is selected, respectively.

This embodiment makes it possible:
when one or more transitions are detected, to obtain a better rendering on the one or more transitions of the signal by selecting the downmixing operation which does not use filtering and which, as a result, preserves the nature of the stereophonic signal,
when no transition is detected, to favor the downmixing operation which uses filtering, which is better suited to components of the stereophonic signal which are not in phase.

In one embodiment, said at least one transient is detected before either of the two downmixing operations is applied to said stereophonic signal.

This embodiment makes it possible, even before a downmixing operation is applied, to deduce a priori that at least one transition is present or not present in the stereophonic signal, without a particular additional processing operation being applied to this signal.

In one embodiment, the detection of said at least one transient comprises the following steps:
decomposing the current frame of the stereophonic signal into sub-blocks;
calculating the energy of each of the obtained sub-blocks;
comparing the obtained energies with an energy threshold (th₆₁); and
if the energy is lower or higher than said energy threshold, respectively, the presence of a transient is not detected or is detected, respectively.

In one embodiment, said filtering quality level is compared with a filtering quality threshold and, if said filtering quality level is below, or above, said filtering quality threshold, the downmixing operation which does not use filtering of the stereophonic signal, or which uses filtering of the stereophonic signal, is selected.

According to one embodiment, said filtering quality level is measured as follows:
calculating the energy of the stereophonic signal, referred to as the input energy, before the filtering is applied,
calculating the energy of the monophonic signal, referred to as the output energy, after the filtering is applied,
calculating a ratio between the input energy and the output energy.

In one embodiment, an indicator representative of the presence or absence of a transient is generated.

In one embodiment, two levels of said processed current frame are respectively obtained after the two downmixing operations, one using filtering of the stereophonic signal and the other not, are applied to said current frame of said signal,
adjusting said level of the current frame to which the downmixing operation using said filtering was applied, said adjusted level being similar to or equal to said level of the current frame to which the downmixing operation not using said filtering was applied;
comparing the processed current frame having said adjusted level and the processed current frame having said level obtained after the downmixing operation not using filtering of the stereophonic signal is applied to said current frame of said signal,
selecting one of said processing operations to be applied to the current frame, based on said comparison.

The invention advantageously makes it possible, when the downmixing operation on a current frame of the stereophonic signal is changed, to keep the level of the stereophonic signal as stable as possible, without leading to discontinuities in the perceived level of the signal.

The invention targets a downmixing device comprising a processing circuit for implementing the steps of the downmixing method as described above.

The invention also relates to a computer program comprising instructions for implementing the downmixing method which is in accordance with the invention, according to any one of the particular embodiments described above, when said program is executed by a processor.

Such instructions may be stored durably in a non-transient memory medium of the downmixing device implementing the downmixing method according to the invention.

This program can use any programming language, and be in the form of source code, object code, or intermediate code between source code and object code, such as in a partially compiled form, or in any other desirable form.

The invention also targets a computer-readable storage medium or information medium comprising instructions of a computer program as mentioned above.

The storage medium may be any entity or device which is capable of storing the program. For example, the medium may comprise a storage means, such as a ROM, for example a CD-ROM or a microelectronic circuit ROM, or indeed a magnetic storage means, for example a mobile medium, a hard disk or an SSD.

Moreover, the storage medium may be a transmissible medium such as an electrical or optical signal, which may be routed via an electrical or optical cable, by radio or by other means, such that the computer program which it contains may be executed remotely. The program according to the invention may, in particular, be downloaded from a network, for example an Internet network.

Alternatively, the storage medium may be an integrated circuit into which the program is incorporated, the circuit being adapted to execute or to be used in the execution of the aforementioned downmixing method.

According to one example of an embodiment, the present technique is implemented by means of software components and/or hardware components. With this in mind, the term “device” or “module” may correspond, in this document, equally to a software component, to a hardware component or to a set of hardware components and software components.

### BRIEF DESCRIPTION OF THE DRAWINGS

Other features and advantages of the invention will become more clearly apparent upon reading the following description of particular embodiments, which are given by way of mere illustrative and non-limiting examples, and the appended drawings, among which:

FIG. 1a illustrates channels of a stereophonic signal, in phase as described above;

FIG. 1b illustrates channels of a stereophonic signal, in phase opposition as described above;

FIG. 2 illustrates, in the form of a block diagram, a downmixing sequence in one embodiment of the invention;

FIG. 3 illustrates one embodiment of a filter calculation for the downmixing, as well as a selection of a downmixing operation;

FIG. 4 illustrates one embodiment of a phase of adapting a downmixing filter;

FIG. 5 illustrates one embodiment of a transition of the application of the downmixing during a transition between two frames of stereo signal;

FIG. 6a illustrates another embodiment of a filter calculation for the downmixing, as well as a selection of a downmixing operation;

FIG. 6b illustrates another embodiment of a filter calculation for the downmixing, as well as a selection of a downmixing operation;

FIG. 7 illustrates an existing downmixing method described above;

FIG. 8 illustrates one example of a structural embodiment of a downmixing device according to one embodiment of the invention.

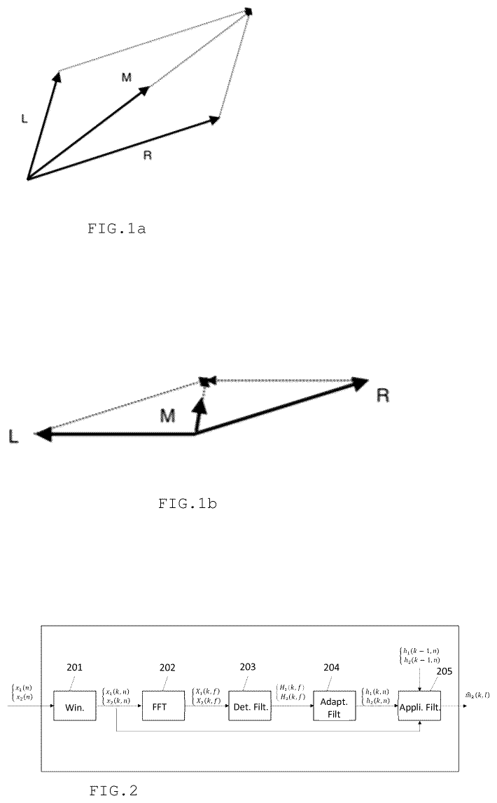

### DESCRIPTION OF THE EMBODIMENTS

The invention will now be described below with reference to FIGS. 2 to 8. To this end, the following symbols will mainly be used in the following description.

### Indices

k frequency index
l temporal index of a signal (in the current frame)
n temporal index of a signal
t frame number

### Constants

L number of samples in the current frame
N number of input channels
M number of output channels
P filter length
Q length of crossfade

### Signals

xᵢ(n) input channels
m(n) downmixing (in the time domain)
m(t,l) downmixing in the current frame (in the time domain)
M(t,k) downmixing in the current frame (in the frequency domain)

FIG. 2 shows one example of a sequence for processing a stereophonic audio signal, the processing operation comprising a downmixing operation.

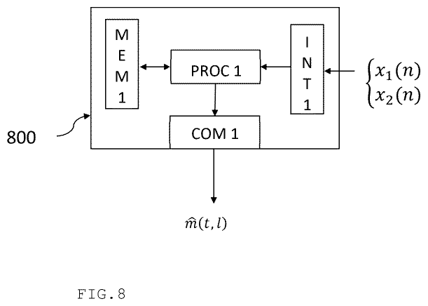

At the input of this processing sequence, a stereophonic signal x, composed of two channels (x₁(n) and x₂(n)), also called the left channel and right channel (respectively), is, in a first stage, divided, in 201, into frames of L samples (x₁(t,l) and x₂(t,l, t being the index of the frame and l the index of the sample. The block 202 applies windowing and an FFT (for fast Fourier transform), in order to obtain signals in the frequency domain (X₁(t,k) and X₂(t,k), k being the index of the frequency). In 203, a downmixing filter to be applied to a signal frame is then selected and determined. This step will be described with reference to FIG. 3. The filter thus determined is conditioned (or adapted) in 204 in order to make it causal and optimize it in order to reduce processing complexity. In one example of an embodiment, the windowing and the FFT are similar to the steps 702 and 703 of FIG. 7.

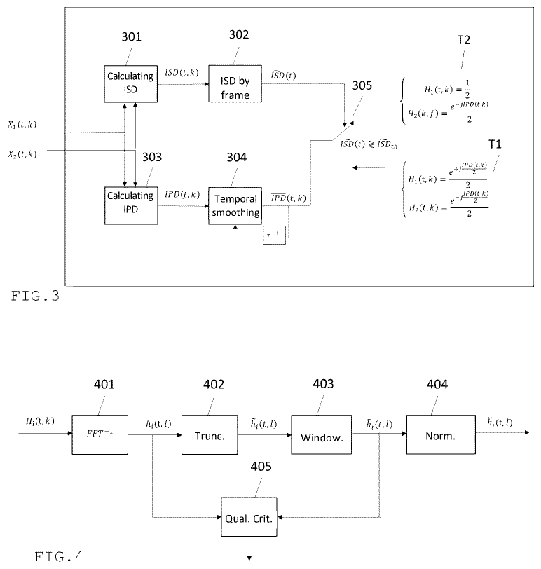

This adaptation phase is described with reference to FIG. 4.

Once the filter has been determined and adapted for the current frame, it is applied, in 205, to this current frame. In order to avoid audible artifacts which are due to a change of filters between two frames, a crossfade is carried out by taking into account the filters of the previous frame

$$\{ \begin{matrix}{h}_{1} ( t - 1 , l ) \\ {h}_{2} ( t - 1 , l )\end{matrix} .$$

This step will be described with reference to FIG. 5.

FIG. 3 describes a detailed embodiment of the block 203 of FIG. 2. In this processing block, a first or a second downmixing operation to be applied to a current frame of the stereophonic signal is selected and determined.

A first downmixing method T1 is defined here by shifting the left channel and right channel of the stereophonic signal simultaneously by an angle defined by half the phase difference (IPD) determined between the two channels of the stereo signal. There is thus a downmixing signal, as follows:

$$M ( t , k ) = \frac{{X}_{1} ( t , k ) \cdot {e}^{+ j \frac{IPD ( t , k )}{2}} + {X}_{2} ( t , k ) \cdot {e}^{- j \frac{IPD ( t , k )}{2}}}{2}$$

This method makes it possible to avoid degradation of reverberation surplus type generated by conventional downmixing (average of the two signals) or of comb filtering type in the event of a temporal shift between the two channels.

This downmixing thus defined may be seen, in the frequency domain, as filtering according to the following equation:

$$M ( t , k ) = {H}_{1} ( t , k ) \cdot {X}_{1} ( t , k ) + {H}_{2} ( t , k ) \cdot {X}_{2} ( t , k ) with$$

$${H}_{1} ( t , k ) = \frac{{e}^{+ j \frac{IPD ( t , k )}{2}}}{2} and {H}_{2} ( t , k ) = \frac{{e}^{- j \frac{IPD ( t , k )}{2}}}{2} .$$

A second downmixing method T2 is, for example, defined as the one proposed in the Samsudin document cited above.

In this second method, then,

$${H}_{1} ( t , k ) = \frac{1}{2} and {H}_{2} ( t , k ) = \frac{{e}^{- jIPD ( t , k )}}{2} .$$

The channels of the stereo signal, in the frequency domain (X₁(t,k) and X₂(t,k)), are used, on one hand, to calculate an ISD phase indicator in 301, which is representative of a measure of the degree of phase opposition between the channels of the stereo signal and, on the other hand, the phase difference between the (IPD) channels in 303.

The phase indicator is, for example, defined by the ISD (inter-spectral distance) indicator as defined above. In the embodiment described here, the ISD is determined by stereophonic signal frame in order for the decision to select a first downmix or a second to be able to be made frame by frame.

This decision by frame makes it possible to dispense with substantial phase shifts between frequencies and with other audible artifacts which may appear when the decision varies from one frequency to the next, as in the patent application cited above.

To apply a decision by frame, a decision criterion according to the ISD phase indicator is defined according to the following equation in 302:

$$\text{?} ( t ) = \frac{total number of frequency lines where ISD ( t , k ) > 1.3}{total number of frequency lines}$$

This criterion measures the percentage of frequency lines of index k for which the criterion is favorable to downmixing with rephasing, that is to say when ISD(t,k)>1.3. The decision is taken to apply the first downmix as defined above, with rephasing, when [symbol] exceeds a certain threshold [symbol] which is set, for example, at 70%.

There is then, in 305, the following selection decision between T1 and T2:

$$\{ \begin{matrix}\text{?} ( t ) < {\text{?}}_{th} : & {H}_{1} ( t , k ) = \frac{{e}^{+ j \frac{IPD ( t , k )}{2}}}{2} , & {H}_{2} ( t , k ) = \frac{{e}^{- j \frac{IPD ( t , k )}{2}}}{2} \\ \text{?} ( t ) > {\text{?}}_{th} : & {H}_{1} ( t , k ) = \frac{1}{2} , & {H}_{2} ( k , f ) = \frac{{e}^{- jIPD ( t , k )}}{2}\end{matrix}$$

In 303, the phase difference IPD is obtained between the two channels of the stereo signal by IPD(t,k)=∠(X₁(t,k)·X*₂(t,k)) where ∠ indicates the phase of the complex operand.

However, the frame decision may sometimes be insufficient since the IPD, as calculated according to the above formula, varies very rapidly over time. Also, the filters

Hᵢ(t,k) may vary very rapidly from one frame to the next, which generates discontinuities which are sometimes audible during the transition from one frame to the next. In order to limit this effect, a version of the IPD which is smoothed over time may be used to calculate the filters Hᵢ(t,k). One way of smoothing the IPD is to apply 1st-order IIR low-pass filtering, in 304, such that:

$$\overline{IPD} ( t , k ) = α ( k ) \overline{IPD} ( t , k ) + ( 1 - α ( k ) ) IPD ( t , k )$$

The forgetting coefficient α(k) is chosen ad hoc. It may be advantageous to choose a high forgetting coefficient at lower frequencies, typically below 5 kHz, since this makes it possible to maintain phase coherence in the lower part of the spectrum from one frame to the next, the spectrum of the speech signals being stationary, notably in its lower part and the particular ear which is sensitive to the phase in this part of the spectrum. By contrast, it is advantageous to choose a low forgetting coefficient at higher frequencies: at higher frequencies, typically above 5 kHz, the phase continuity of the speech signals is less marked and the ear is less sensitive to phase discontinuities in this part of the spectrum.

A forgetting coefficient of the following form may be chosen:

$$α ( k ) = \{ \begin{matrix}{α}_{max} , & k < {k}_{low} \\ {α}_{min} , & k > {k}_{high} \\ {α}_{min} + \frac{k - {k}_{low}}{{k}_{high} - {k}_{low}} & {k}_{low} < k < {k}_{high}\end{matrix}$$

The values αₘₐₓ, αₘᵢₙ, k_{high} and k_{low} are determined experimentally. In the case of adjacent frames of length L=20 ms, the following set of parameters may, for example, be chosen:

αₘₐₓ=0.94, αₘᵢₙ=0.86, k_{low}=0, k_{high}, corresponds to 5 kHz.

In some variants, very low frequencies and very high frequencies will be forced to remain intact. Thus, in some variants,

$${H}_{1} ( t , k ) = {H}_{2} ( t , k ) = \frac{1}{2}$$

is forced for the first lines k=0 or k=0, 1 as well as for the lines of index k>kₘₐₓ, where k corresponds to 8 KHz.

FIG. 4 presently details the block 204 of FIG. 2. The filters Hᵢ(t,k) as, for example, defined in the downmixing methods T1 and T2 defined above, are reconditioned or indeed adapted in order to avoid circular convolution.

In a first step, in 401, the impulse responses hᵢ(t,l) of the filters Hᵢ(t,k) are calculated, such that:

$${h}_{i} ( t , l ) = {FFT}^{- 1} \{ {H}_{i} ( t , k ) \} , i = 1 , 2$$

where the filters hᵢ(t,l) are of size N, which corresponds to the length of the FFT. Here, N=L.

In the preferred embodiment, L=20 ms, or 320 samples at 16 kHz, 640 samples at 32 kHz and 960 samples at 48 KHz.

The impulse responses thus defined are conventionally non-causal, they correspond to finite impulse response filters. One conventional technique for making them causal consists in rotating L/2 samples in order to center the response in L/2. The drawback is that the filter thus reconstructed then exhibits a latency of L/2. In order to avoid this latency, the choice is made to truncate the filter asymmetrically, in 402, retaining only a portion of the first half of the impulse response hᵢ(t,l) as follows:

$${\tilde{h}}_{i} ( t , l ) = {h}_{i} ( t , l ) , 0 \leq l < P \leq L / 2$$

This filter exhibits the advantage of generally having a maximum (in absolute value) on its first sample, which guarantees processing without an additional delay. In terms of frequency response, it exhibits a phase which is almost equal to the optimal rephasing filter hᵢ(t,l).

The choice of P depends on various criteria: a value of P which is close to N/2 guarantees near-optimal rephasing, whereas a lower value makes it possible to limit the computational power which is necessary for filtering. A low value of P also results in smoothing the phase of the filter. This exhibits an advantage with filters defined by the processing operation T2 as defined above, where the phase varies very rapidly from one frequency to the next: these variations may result in a very high group delay which is perceptible to the human ear. A low value of P makes it possible to remove all or some of these artifacts.

The filter thus truncated \tilde{h}ᵢ(t,l), notably when P<N/2, or even P<<N/2, exhibits an impulse response tail which does not tend toward 0. This creates audible clicking discontinuities at the transition between 2 frames. Thus, in order to avoid these audible artifacts, \tilde{h}ᵢ(t,l) is weighted with a window w(l), in 403, such that:

$$\check{h} ( t , l ) = w ( l ) \cdot {\tilde{h}}_{i} ( t , l )$$

where the coefficients of w(l) tend toward 0 when 1 tends toward P. This makes it possible to reduce the energy of the samples at the end of the filter and to avoid discontinuities during the transition between filters of consecutive frames.

This window may be a triangular half-window, or indeed a Hann half-window:

$$w ( l ) = \{ \begin{matrix}1 - l / P \\ cos ( l π / 2 P ) \\ …\end{matrix}$$

On account of its truncation and the windowing, the filters \tilde{h}ᵢ(t,l) have a reduced energy with respect to that of the optimal filter hᵢ(t,l): the latter, as a pure phase-shifting filter, has a norm ½ by construction. Thus, the energy of the filter thus truncated and windowed may be normalized, in 404, such that:

$${\breve{h}}_{i} ( t , l ) = \frac{{\check{h}}_{i} ( t , l )}{2 ‖ {\check{h}}_{i} ( t , l ) ‖}$$

where ∥x(⋅)∥ is the norm 2 of a vector.

According to the invention, in 405, a quality level of the filtering which has been implemented is determined. To this end:
an energy E₄₀₁ of the filter before truncation 402 is calculated;
an energy E₄₀₃ of the temporal filter after windowing 403 is calculated;
a ratio R₄ between E₄₀₁ and E₄₀₃ is calculated.

A filtering quality may also be determined by comparing an energy E₄₀₁ and an energy E₄₀₄ of the temporal filter after normalization.

By way of non-exhaustive alternatives, the quality level of filtering may be determined:
directly on the filter Hᵢ(t,k), and/or
a frequency version of this same filter before normalization H̆ᵢ(t,k) or after normalization H̆ᵢ(t,k).
etc.

In some variants, it is possible to calculate:

$${\sum }_{l = 0}^{P - 1} {( {h}_{i} ( t , l ) - {\check{h}}_{i} ( t , l ) )}^{2}$$

This criterion may be normalized by:

$${\sum }_{l} {{h}_{i} ( t , l )}^{2}$$

Another variant of quality may be concerned with measuring the amount of energy lost during truncation in order to make the filter causal. In this variant, E₄₀₁ may be calculated as the “anticausal” energy of the original filter:

$${E}_{401} ( t ) = {\sum }_{l = N / 2}^{N - 1} {h}_{i}^{2} ( t , l )$$

The energy E₄₀₃ (or E₄₀₄) may be calculated as the energy of the synthesized filter, before normalization (or after normalization):

$${E}_{403} ( t ) = {\sum }_{l = 1}^{P - 1} {\check{h}}_{i}^{2} ( t , l ) \\ {E}_{404} ( t ) = {\sum }_{l = 1}^{P - 1} {\breve{h}}_{i}^{2} ( t , l )$$

In order to avoid the bias linked to the size of the window, the energy of the anticausal part may also be calculated over the same number of samples, with or without windowing by the window w(l):

$${E}_{401} ( t ) = {\sum }_{l = \frac{N}{2} - P}^{N - 1} {h}_{i}^{2} ( t , l ) \\ {E}_{401} ( t ) = {\sum }_{l = N - P}^{N - 1} w ( N - l + P ) {h}_{i}^{2} ( t , l )$$

In some variants, the frequency response Hᵢ(t,k) of the filter obtained after truncation (at the output of 403) may be calculated and compared with the target response Hᵢ(t,k) in order to define the quality level, for example:

$${\sum }_{k} {\vert {H}_{i} ( t , k ) - {\check{H}}_{i} ( t , k ) \vert}^{2}$$

This criterion may be normalized by:

$${\sum }_{k} {\vert {H}_{i} ( t , k ) \vert}^{2}$$

Another variant of the quality criterion may consist in comparing the phase coherence of the filters, given that the objective is to rephase signals. Thus, the coherence C_{H}_{ᵢ}_{,H̆}ᵢ(t) between the 2 filters may be calculated:

$${C}_{{H}_{i} , {\check{H}}_{i}} ( t ) = \frac{1}{N} \vert {\sum }_{k} \frac{{H}_{i} ( t , k ) {\check{H}}_{i}^{*} ( t , k )}{\vert {H}_{i} ( t , k ) {\check{H}}_{i}^{*} ( t , k ) \vert} \vert$$

A high coherence (i.e. which is close to 1) indicating that the synthesized filter is close to the ideal filter and therefore a high quality factor, a low value (which is close to 0) indicating, by contrast, a low quality criterion.

FIG. 5 presently describes the block 205 of FIG. 2, where an OLS (overlap-save) implementation of the filtering is performed in the time or frequency domain, in detail. The choice of domain will be made depending on complexity, which depends on the size of the filter relative to that of the frame to be processed.

An OLS implementation in the time domain is presented here, with adjacent frames of size L.

In a first stage, the current frame is concatenated, in 501, with the P−1 samples of the previous frame (save principle):

$${\tilde{x}}_{i} ( k , . ) = [ {x}_{i} ( tL - P + 2 ) , … , {x}_{i} ( tL - 1 ) , {x}_{i} ( tL ) , … {x}_{i} ( ( t + 1 ) L - 1 ) ]$$

Each channel is filtered by its phase-shifting filter in 503:

$${y}_{i} ( t , l ) = {\sum }_{p = 0}^{P - 1} {\breve{h}}_{i} ( t , p ) \cdot {\tilde{x}}_{i} ( t , l + P - p ) , 0 \leq l < L$$

The mono downmix is then created by summing the two channels rephased in 505:

$$m ( t , l ) = {y}_{1} ( t , l ) + {y}_{2} ( t , l ) , 0 \leq l < L$$

In practice, the filters may be very different between two successive frames, for example when a new source appears. In this case, the transition between mₜ₋₁ (t,l) and m(t,l) may occasion differences in the form of audible artifacts. To avoid these artifacts, a cross-fade step may be applied. In order to carry out this cross-fading, the filters h̆ᵢ(t−1,l) are applied to the current frame over a number of samples Q:

$${y}_{i , t - 1} ( t , l ) = {\sum }_{p = 0}^{P - 1} {\breve{h}}_{i} ( t - 1 , p ) \cdot {\tilde{x}}_{i} ( t , l + P - p ) , 0 \leq l < Q$$

This is carried out by the block 502 of FIG. 5.

The number of samples which are necessary for the cross-fading will have to be determined experimentally, depending on the size of the filters, on the sampling frequency etc.

Next, the mono downmix mₜ₋₁(t,l) is created in 504, from filters of the previous frame:

$${m}_{t - 1} ( t , l ) = {y}_{1 , t - 1} ( t , l ) + {y}_{2 , t - 1} ( t , l ) , 0 \leq l < Q$$

The signal resulting from the downmix \hat{m}(t,l) is created in 506, on the basis of a cross-fade according to the following equation:

$$\hat{m} ( t , l ) = \{ \begin{matrix}β ( l ) \cdot {m}_{t - 1} ( t , l ) + ( 1 - β ( l ) ) \cdot m ( t , l ) , & 0 \leq l < Q \\ m ( t , l ) , & Q \leq l < L\end{matrix}$$

where β(l) is a decreasing monotonic function, with β(0)=1 and β(Q−1)=¿ with a being a value which is close to 0 or is zero. Typically, a Hann half-window may be chosen:

$$β ( l ) = cos ( \frac{l π}{2 Q} ) , 0 \leq l < Q$$

It should be noted that, in an integration with many other downmixing methods, the aforementioned downmixing methods T1 and T2 cannot always be represented by a filtering operation. This is the case for the method T3 of FIG. 7 or any other method the gain of which depends on the instantaneous level of the signal.

According to the invention, in the case where a selection of the downmixing methods T1 and T2 or the downmixing method T3 is implemented, as will be described in the remainder of the description, a step 5040 and 5050 of scaling each of the signals mₜ₋₁(t,l) and m(t,l), respectively, is implemented. To this end, the signal (n) obtained at the output of the downmix T3 of FIG. 7 having a level N3, the level N1, or N2, of each of the signals mₜ₋₁(t,l) and m(t,l) to which the downmix T1, or T2, has been applied is adjusted to the level N3, so as to be equal or similar to this level N3. Instead of being applied to each of the signals mₜ₋₁(t,l) and m(t,l), such scaling can also be carried out on the signal m(t,l).

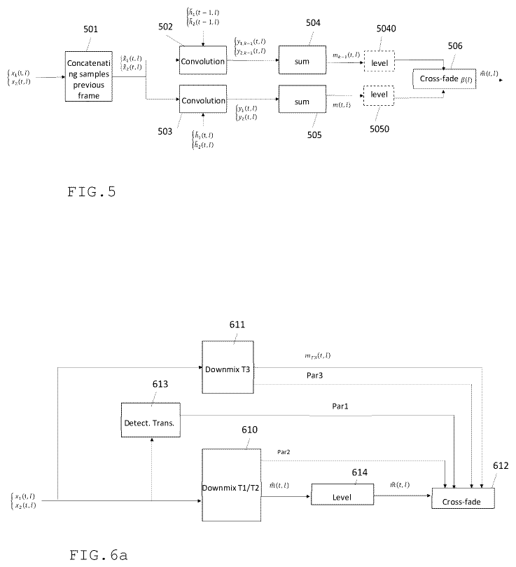

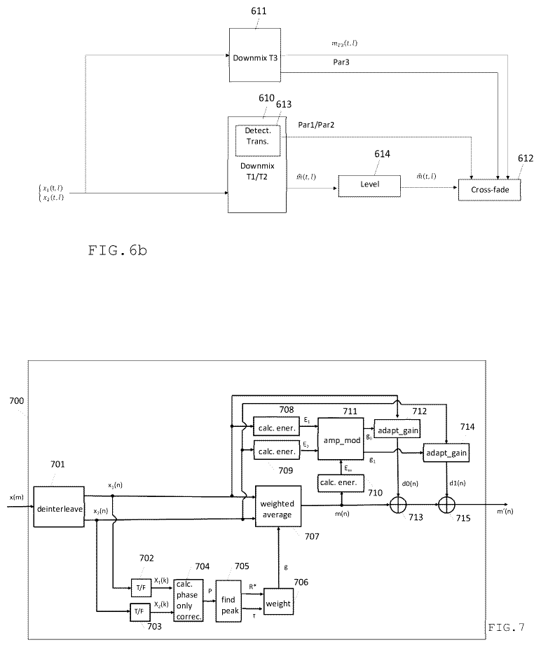

FIG. 6a presently details a downmixing method which is in accordance with the invention, wherein one of the downmixing methods T1 or T2 chosen at the end of the selection method of FIG. 3 is implemented in 610, and another downmixing method is implemented in 611, the gain of which depends on the instantaneous level of the signal, such as, for example, the method T3 of FIG. 7.

In this case, one solution is to calculate the downmixes of each method for the current frame of temporal index l and to perform a transition, in 612, from one downmix to the next by cross-fading, which generates a monophonic signal d(n). More specifically, in the case of a transition from a downmix T1 (or T2) to the downmix T3, the downmixing may be performed between the signal \hat{m}(t,l) obtained at the output of T1 (or T2) and the signal m_{T3}(t,l) obtained at the output of T3. The downmix may also be performed between the output of T1 (or T2) and the signal d(n). In this latter case, the energy compensation of the method T3 (adapt_gain in FIG. 7) would be applied to all the methods continuously. The decision to switch from a downmix T1 or T2 to a downmix T3 may be motivated by other criteria than the ISD, for example parameters Par3 already calculated by the method T3, such as, for example, the ITD, by choosing to apply the downmix T3 by default when the ITD is very large (for example, ITD>600 microsec in absolute value), or any other criterion or combination of criteria.

In accordance with the invention, the downmix T1 (or T2) or T3 is selected depending on:
a presence or absence of at least one transition in the stereophonic signal, or
a quality level of the filtering of the stereophonic signal used when the downmix T1 (or T2) is implemented.

In the case of a detection 613 of the presence or absence of at least one transition in the stereophonic signal, according to a first embodiment, detection of a transient is applied separately to each of the input signals x₁(n) and x₂(n), or to the current frame x₁(t,l) and x₂(t,l). Since the detection of transients is a conventional problem in audio coding, the example of the module already implemented in the EVS codec and described in the 3GPP standard TS 26.445 clause 5.1.8 is taken. To this end, each of the input signals x₁(n) and x₂(n), or the current frame x₁(t,l) and x₂(t,l) is divided into sub-blocks. The energy of each sub-block is calculated, then smoothing is optionally implemented. The energy obtained is then compared with an energy threshold th₆₁. If this energy obtained is below th₆₁, the presence of a transition is considered to be not detected. If this energy obtained is above th₆₁, the presence of a transition is considered to be detected. To this end, a parameter Par 1 (if T1 was chosen at the end of the selection of FIG. 3) or Par2 (if T2 was chosen at the end of the selection of FIG. 3) is set:
to a first value, for example 0, in order to indicate that the presence of a transition has not been detected,
to a second value, for example 1, in order to indicate that the presence of a transition has been detected.

Such a parameter Par1/Par2 is transmitted, as a decision criterion, to the cross-fading block 612.

In the case where the downmix T1 (or T2) or the downmix T3 is selected based on a quality level of the filtering of the stereophonic signal used when the downmix T1 (or T2) is implemented, with reference to FIG. 4, the following steps are implemented:
calculating the energy of E₆₁ the signal ŷᵢ(t,l), resulting from the filtering \tilde{x}₁(t,l) by hᵢ(t,l)
calculating the energy E₆₂ of the signal yᵢ(t,l),
calculating a ratio between E₆₁ and E₆₂,
comparing said ratio with an energy threshold SE.

If the ratio between E₆₁ and E₆₂ is below SE, the presence of a transition is considered to be detected. If the ratio between E₆₁ and E₆₂ is above SE, the presence of a transition is considered to be detected. To this end, a parameter Par 1 (if T1 was chosen at the end of the selection of FIG. 3) or Par2 (if T2 was chosen at the end of the selection of FIG. 3) is set:
to a first value, for example 0, in order to indicate that the presence of a transition has not been detected,
to a second value, for example 1, in order to indicate that the presence of a transition has been detected.

Such a parameter Par1/Par2 is transmitted, as a decision criterion, to the cross-fading block 612.

Thus, according to the invention, when a transient is detected in the current frame in one or both channels, the downmix T3 is applied to the current frame rather than the downmix T1 (or T2). Specifically, the downmixes T1 and T2 use filtering by an impulse response which sometimes has a tendency to spread the envelope of the signal; this problem is more pronounced in transient sounds such as castanets, scissors clicking on a binaural recording simulating a haircut at a hairdresser's etc.

In order to limit potential artifacts due to the cross-fading (block 612) between downmixing methods, the invention may make provision for applying, in 614, scaling of the signal at the output of T1 (or T2). According to the invention, such scaling 614 implements the following steps:
determining the energy E′ of the downmixing signal at the output of T1 (or T2), preferably with smoothing, by carrying out the same steps as the steps 708, 709 and 710 of FIG. 7,
determining the scale factor:

$${g}^{′} = \sqrt{\frac{{E}_{1} + {E}_{2}}{2 {E}^{′}}}$$

applying the factor g′ to said downmixing signal by returning to the principle of operation (with smoothing at the start of the frame) of the blocks 712 and 714 of FIG. 7.

Unlike the downmix in FIG. 7, a direct compensation of the level of the downmix at the output of T1 or T2 is applied here, without reinjecting an input signal.

FIG. 6b illustrates one alternative to the downmixing method described with reference to FIG. 6a.

The embodiment illustrated in FIG. 6b is distinguished from that of FIG. 6a only by the fact that a transition is detected according to a second embodiment. According to this second embodiment, such detection is implemented during the step 610 of downmixing T1 (or T2) instead of being applied separately to each of the input signals x₁(n) and x₂(n), or to the current frame x₁(t,l) and x₂(t,l). To this end, with reference to FIG. 5, the energy of each 2-ms sub-block is compared between the input and output signal of the blocks 502 and 503. If the energy has lowered a threshold, for example 3 dB, it is considered that a transient has been greatly attenuated, and in this case the downmix T3 is applied in the current frame. If the energy has not lowered a threshold, for example 3 dB, it is considered that a transient has not been attenuated, and in this case the downmix T1 (or T2) is applied in the current frame.

FIG. 8 illustrates a downmixing device 800, within the meaning of the invention.

The device 800 comprises a processing circuit typically including:
a memory MEM1 for storing instruction data of a computer program within the meaning of the invention;
an interface INT1 for receiving a stereo audio signal:

$$\{ \begin{matrix}{x}_{1} ( n ) \\ {x}_{2} ( n )\end{matrix} ;$$

a processor PROC1 for receiving this signal and processing it executing by the computer program instructions which the memory MEM1 stores, with a view to carrying out downmixing; in particular, the processor being able to control the processing modules as described with reference to FIGS. 2 to 5; and
a communication interface COM 1 for transmitting the reduced signals, resulting from the downmixing, m(t,l), to another processing module, for example a coding or decoding module of an audio signal coder or decoder.

Of course, this FIG. 8 illustrates one example of a structural embodiment of a downmixing device within the meaning of the invention.

FIGS. 2 to 7, commented on above, describe functional embodiments of this device in detail.

The applications of this type of downmixing are, for example, in audio coding, for example when the remote does not have the capabilities for rendering stereo sound on its terminal. In this case, it is not necessary to transport a stereo signal, and this makes it possible to save bandwidth. This type of method may operate during point-to-point conversations if one of the participants makes a stereo or binaural sound recording. This type of method may also be present during a multiparty call: the conference bridge spatializes the scene by creating a stereo scene, but not all the participants necessarily have stereo rendering capabilities. The scene should then be downmixed in mono for these participants.

The invention may also apply to audio decoding: in this case, it is the renderer (rendering module) of the user which will downmix the stereo content in order to adapt to the reduced capabilities of the user (a mere loudspeaker, for example).

1. A downmixing method for downmixing a stereophonic signal in order to obtain a monophonic signal, wherein the signal has channels and the method is performed by a downmixing device and comprises:
applying, to a current frame of said signal, first and second downmixing operations, one of the first and second downmixing operations using filtering with rephasing on at least one of the channels of the stereophonic signal and the other of the first and second downmixing operations not using filtering with rephasing; and
selecting one of said first or second downmixing operations to be applied to the current frame, said selecting being implemented depending on:
a presence or absence of at least one transient in the stereophonic signal, or
a quality level of the filtering of the stereophonic signal used when implementing the first or second downmixing operation using the filtering of the stereophonic signal.

2. The downmixing method as claimed in claim 1, wherein, if a presence of said at least one transient is detected, or not detected, in the stereophonic signal, the first or second downmixing operation which does not use filtering of the stereophonic signal, or which uses filtering of the stereophonic signal, is selected, respectively.

3. The downmixing method as claimed in claim 1, wherein said at least one transient is detected before one of the first or second downmixing operations is applied to said stereophonic signal.

4. The downmixing method as claimed in claim 1, wherein the detection of said at least one transient comprises:
decomposing the current frame of the stereophonic signal into sub-blocks;
calculating the energy of each of the obtained sub-blocks;
comparing the calculated energies with an energy threshold; and
if the energy is lower or higher than said energy threshold, respectively, the presence of a transient is not detected or is detected, respectively.

5. The downmixing method as claimed in claim 1, wherein said filtering quality level is compared with a filtering quality threshold and, if said filtering quality level is below, or above, said filtering quality threshold, the first or second downmixing operation which does not use filtering of the stereophonic signal, or which uses filtering of the stereophonic signal, is selected.

6. The downmixing method as claimed in claim 5, wherein said filtering quality level is measured as follows:
calculating energy of the stereophonic signal, referred to as input energy, before the filtering is applied,
calculating energy of the monophonic signal, referred to as output energy, after the filtering is applied,
calculating a ratio between the input energy and the output energy.

7. The downmixing method as claimed in claim 1, wherein an indicator representative of the presence or absence of a transient is generated.

8. The downmixing method as claimed in claim 1, wherein first and second levels of said processed current frame are respectively obtained after the first and second downmixing operations, one using filtering of the stereophonic signal and the other not, are applied to said current frame of said signal,
adjusting said first level of the current frame to which the first or second downmixing operation using said filtering was applied, said adjusted first level being similar to or equal to said second level of the current frame to which the first or second downmixing operation not using said filtering was applied.

9. A downmixing device comprising:
a processing circuit which is configured to implement a method for downmixing a stereophonic signal in order to obtain a monophonic signal, wherein the signal has channels and the method comprises:
applying, to a current frame of said signal, first and second downmixing operations, one of the first and second downmixing operations using filtering with rephasing on at least one of the channels of the stereophonic signal and the other of the first and second downmixing operations not using filtering with rephasing; and
selecting one of said first or second downmixing operations to be applied to the current frame, said selecting being implemented depending on:
a presence or absence of at least one transient in the stereophonic signal, or
a quality level of the filtering of the stereophonic signal used when implementing the first or second downmixing operation using the filtering of the stereophonic signal.

10. A non-transitory computer readable storage medium storing a computer program comprising instructions for executing a method for downmixing a stereophonic signal in order to obtain a monophonic signal, when the instructions are executed by at least one processor of a downmixing device, wherein the signal has channels and the method comprises:
applying, to a current frame of said signal, first and second downmixing operations, one of the first and second downmixing operations using filtering with rephasing on at least one of the channels of the stereophonic signal and the other of the first and second downmixing operations not using filtering with rephasing; and
selecting one of said first or second downmixing operations to be applied to the current frame, said selecting being implemented depending on:
a presence or absence of at least one transient in the stereophonic signal, or
a quality level of the filtering of the stereophonic signal used when implementing the first or second downmixing operation using the filtering of the stereophonic signal.
